(19) United States
(12) Patent Application Publication
(10) Pub. No.: US 2026/0192484 A1
(43) Pub. Date: Jul. 9, 2026

(54) SAWING MACHINE WITH LIFTABLE SAW BLADE GUARD

(71) Applicant: DURQ MACHINERY CORP., TAICHUNG CITY (TW)

(72) Inventors: Chia-Sheng LIU, TAICHUNG CITY (TW); Chieh-Yuan TSAI, TAICHUNG CITY (TW); Shih-Hui LINE, TAICHUNG CITY (TW)

(21) Appl. No.: 19/065,761

(22) Filed: Feb. 27, 2025

(30) Foreign Application Priority Data
Jan. 3, 2025 (TW) 114100297

(51) Int. Cl. B27G 19/02

(52) U.S. Cl. CPC B27G 19/025

(57) ABSTRACT

A sawing machine includes a machine body, a saw blade guard, a guide mechanism, and a covering element. The machine body has a worktable, a machining module, an arm pivotally connected with the worktable and machining module. The saw blade guard has a fixed guard, a movable guard, and an elastic member connected with the fixed guard and the movable guard. The guide mechanism has one end provided with a first guide groove and connected with the movable guard. The covering element is disposed to the saw blade guard and driven to move when the movable guard is moved along the first guide groove of the guide mechanism. Thus, when the machining module is moved downward relative to the arm, the movable guard is automatically lifted through the elastic member.

### BACKGROUND OF THE INVENTION

### 1. Field of the Invention

The present invention relates to sawing machines and more particularly, to a sawing machine that has a liftable saw blade guard.

### 2. Description of the Related Art

The sawing machine is a widely used product among power tools. Depending on the speed and type of the saw blade, it can be used to cut materials such as stone, tiles, wood, or metal. Currently, there are also portable handheld circular saws or cutting machines, which make it convenient for users to perform cutting tasks directly on materials at the processing site. To cut through hard materials, the saw blade has a very sharp edge. Therefore, when not in use, the saw blade needs to be protected with a saw blade guard to prevent accidental cuts that could injure the user.

When performing actual cutting tasks, the user needs to hold the handle with one hand and use the other hand to lift the saw blade guard, exposing the blade to make contact with the workpiece. The user must maintain this posture while cutting. However, during the cutting process, since the user is operating with only one hand, it increases the risk of accidents. Furthermore, in order to improve the safety of the sawing machine, the design of the saw blade guard becomes crucial. Currently, the saw blade guard can completely protect the saw blade to prevent accidental contact by the user. However, as the structure of the saw blade guard becomes more complex, the task of changing the saw blade becomes more cumbersome and time-consuming, reducing work efficiency.

CN 220073431 U provides a metal cutting machine with an easy blade replacement mechanism. This patent discloses a first protective cover and a second protective cover, which are secured together by a clamping plate that fits into a L-shaped groove of the first guide plate of the first protective cover and a L-shaped groove of the second guide plate of the second protective cover. By using a screw to rotate the clamping plate, the user can release the connection between the first and second protective covers, allowing the second protective cover to be removed and the saw blade to be replaced. However, the design of this saw blade guard requires changes to its shape, leading to higher manufacturing costs. Additionally, during machine operation, vibrations may cause the screw to loosen, affecting the stability of the first and second protective covers and potentially creating safety hazards for the user.

Therefore, how to provide a sawing machine that can automatically lift the saw blade guard and have a structure that is convenient for the user to replace the saw blade. This is the direction that the inventor is thinking about.

### SUMMARY OF THE INVENTION

It is one objective of the present invention to provide a sawing machine, which can automatically lift a saw blade guard while performing sawing operation, and can provide an advantage of quick blade replacement through an interlocking mechanism.

To attain the above objective, the sawing machine of the present invention comprises a machine body, a saw blade guard, a guide mechanism, and a covering element. The machine body has a worktable, a machining module, and an arm pivotally connected to the worktable and the machining module. The saw blade guard is attached to the machining module of the machine body and has a fixed guard, a movable guard, and an elastic member connected to the fixed guard and the movable guard. When the machining module is moved downward relative to the arm, the movable guard is lifted relative to the fixed guard through the elastic member. The guide mechanism is disposed to the movable guard and has one end thereof provided with a first guide groove and connected with the movable guard. The covering element is disposed to the saw blade guard and driven by the movable guard to move when the movable guard is moved along the first guide groove of the guide mechanism and pivoted relative to the fixed guard.

It can be seen from the above that when the sawing operation is performed, the machining module is moved downward relative to the arm, bringing it closer to a workpiece. As the machining module is moved, the movable guard is simultaneously lifted due to an elastic force of the elastic member, allowing for smooth sawing of the workpiece. Furthermore, when manually lifting the movable guard, a user needs to apply force to overcome the elastic force of the elastic member. Once a certain force is reached, the movable guard is opened and drives the covering element to rotate, thus allowing the user to easily perform maintenance on the machining module.

Preferably, the machining module includes a housing, a motor installed in the housing, a saw blade connected to the motor through a spindle screw, and a handle fixed to the housing. In this way, the machining module is driven by the motor to rotate and operated by the user holding the handle to perform cutting operation. The spindle screw is covered by the covering element and exposed for disassembly when the saw blade needs to be replaced.

Preferably, one end of the arm is pivotally connected with the worktable through a lower shaft, and the other end of the arm is pivotally connected with the machining module and the guide mechanism through an upper shaft. In this way, the arm drives the machining module to move forward and backward through the lower shaft and drives the machining module to move downward relative to the arm through the upper shaft for performing sawing operation.

Preferably, the guide mechanism is connected with the movable guard through a pin inserted in the first guide groove. In this way, the guide mechanism drives the machining module, allowing the machining module to make fine adjustments to its angle through the motion of the guide mechanism. The movable guard can travel along the first guide groove until it is fully lifted over the top of the fixed guard, allowing the user to focus on replacing the saw blade.

Preferably, the guide mechanism further includes a second guide groove, and the guide mechanism is connected with the machining module through a pin inserted in the second guide groove, allowing the machining module to be moved downward relative to the arm. In this way, when the sawing operation is performed by the machining module, the second guide groove can limit the downward movement of the machining module, thereby enhancing the accuracy of the cutting position.

Preferably, the other end of the guide mechanism is fixed to the worktable. In this way, the guide mechanism can not only be firmly fixed on the worktable, but also drive the machining module through the other end of the guide mechanism, so that the machining module can be easily adjusted to an ideal position.

Preferably, the saw blade guard further includes a connecting plate fixed to one end of the elastic member and a third guide groove formed on the connecting plate. The covering element is penetrated through the third guide groove and abutted against an inner surface of the movable guard, allowing the covering element to be moved along the third guide groove. In this way, the covering element can be driven by the movable guard to move. When the covering element is moved, the spindle screw is exposed.

Preferably, the inner surface of the movable guard has a connecting portion fixed to one end of the elastic member, a connecting hole provided at a center of the connecting portion, and at least one push portion formed on the connecting portion and abutted against the covering element. The movable guard is pivotally connected with the fixed guard through a pin inserted in the connecting hole. In this way, the movable guard can be pivoted relative to the fixed guard through the pin, and the elastic member provides the elastic force to automatically lift and reset the movable guard.

Preferably, the elastic member is a torsion spring. In this way, when the machining module is moved downward, the elastic member applies a torsional force to the movable guard, causing the movable guard to be lifted.

Preferably, the covering element includes a protrusion abutted against the inner surface of the movable guard through the fixed guard and a linking hole passing through two opposite sides of the covering element. The covering element is connected with the fixed guard through a pin inserted in the linking hole. In this way, the covering element is movably disposed on the fixed guard and the movable guard to cover or not cover the spindle screw.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a sawing machine of the present invention.

FIG. 2 is another perspective view of the sawing machine of the present invention from different angles.

FIG. 3 is an exploded view of the sawing machine of the present invention.

FIG. 4 is an exploded view of a saw blade guard provided by the sawing machine of the present invention.

FIG. 5 is an exploded view of a guide mechanism provided by the sawing machine of the present invention.

FIG. 6 is an exploded view of a lock mechanism provided by the sawing machine of the present invention.

FIG. 7 is a right-side view of the sawing machine of the present invention, showing that the saw blade guide is opened.

FIG. 8 is an enlarged view of the sawing machine of the present invention, showing that the covering element covers the spindle screw.

FIG. 9 is an enlarged view of the sawing machine of the present invention, showing that the positional relationship between the covering element and the movable guard.

FIG. 10 is a lateral view of the sawing machine of the present invention, showing that the positional relationship of each element when the saw blade is replaced.

FIG. 11 is a right-side view of the sawing machine of the present invention, showing that the machining module is located at the second position.

FIG. 12 is a left-side view of the sawing machine of the present invention, showing that the machining module is located at the second position.

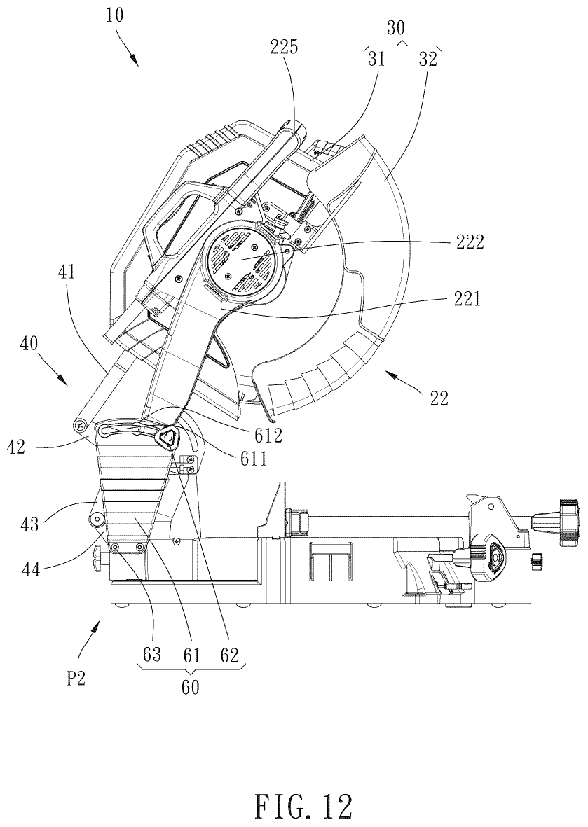

FIG. 13 is a right-side view of the sawing machine of the present invention, showing that the machining module is located at the third position.

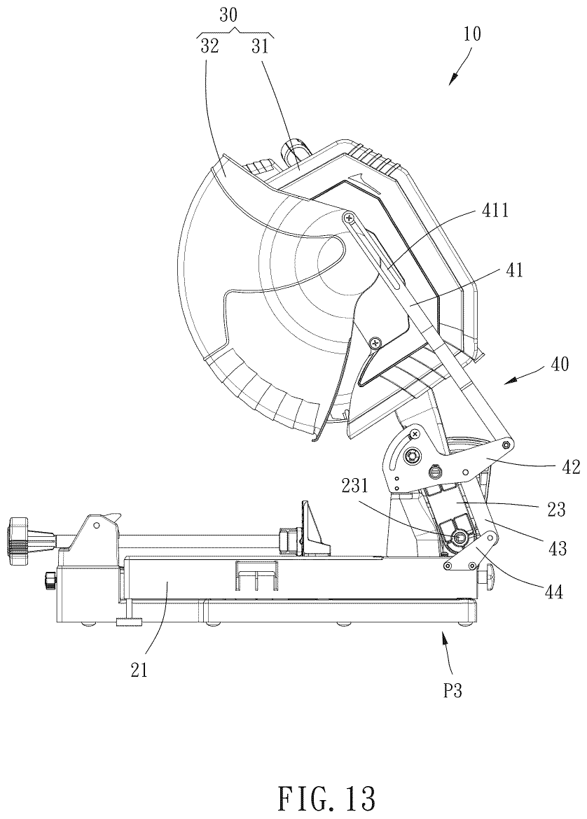

FIG. 14 is a left-side view of the sawing machine of the present invention, showing that the machining module is located at the third position.

### DETAILED DESCRIPTION OF THE INVENTION

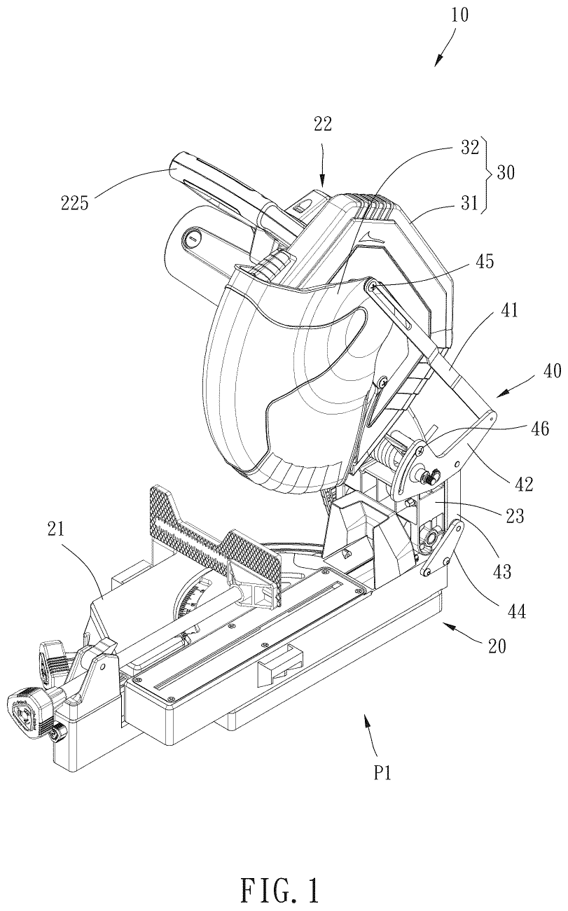

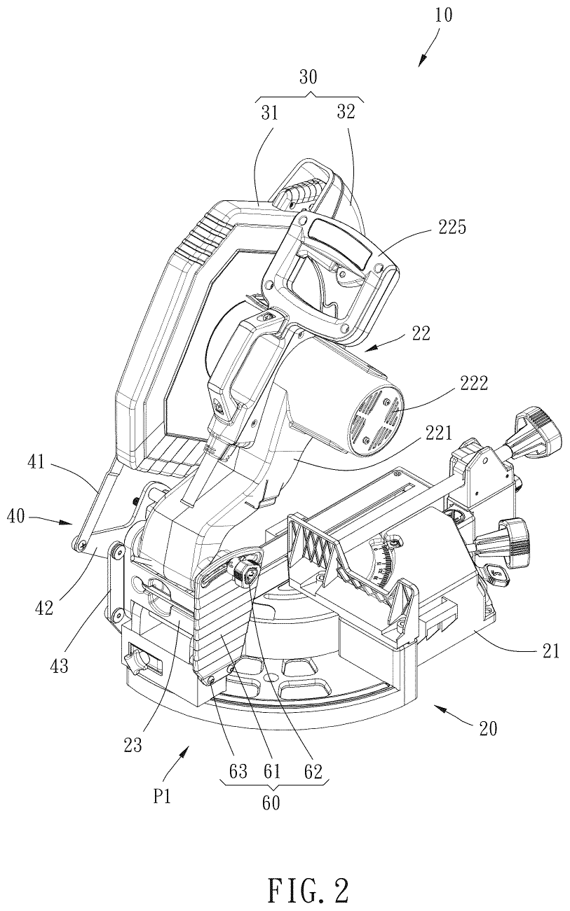

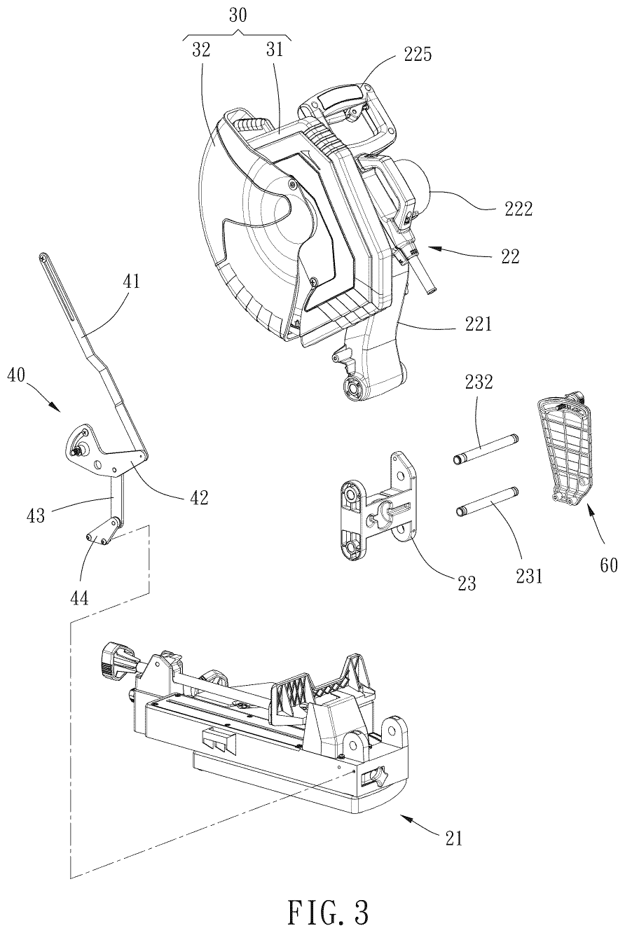

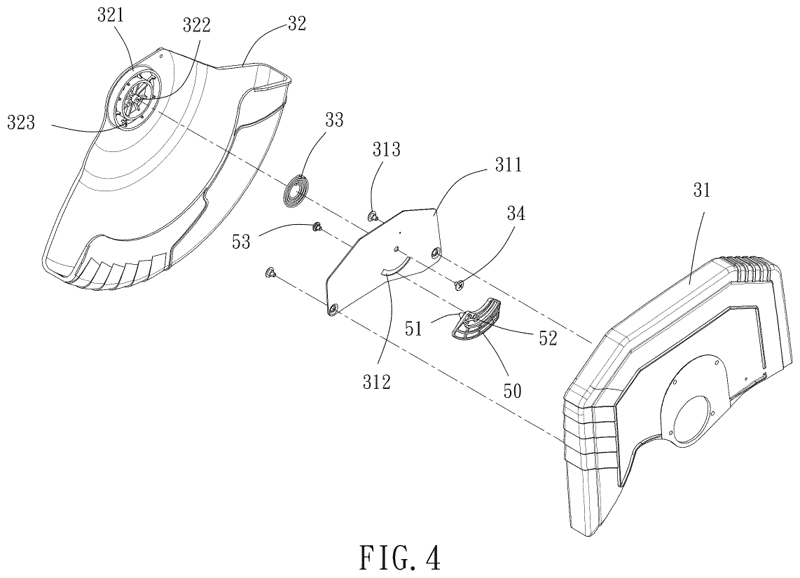

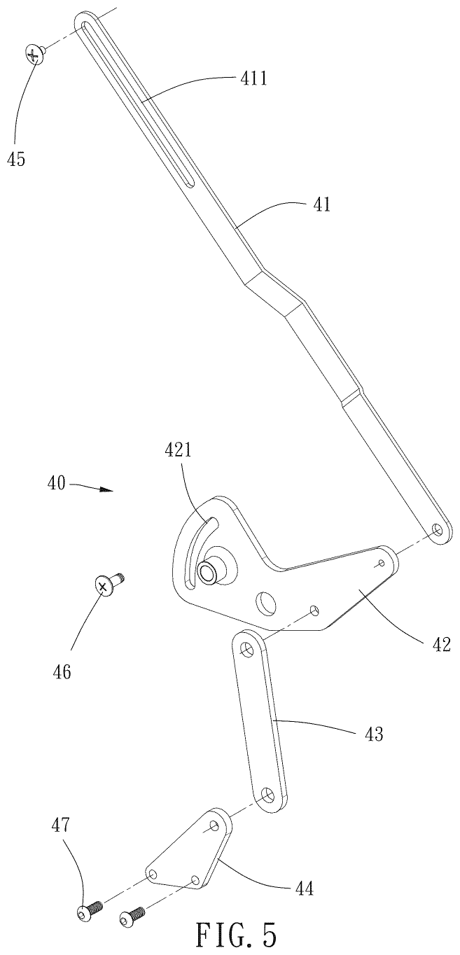

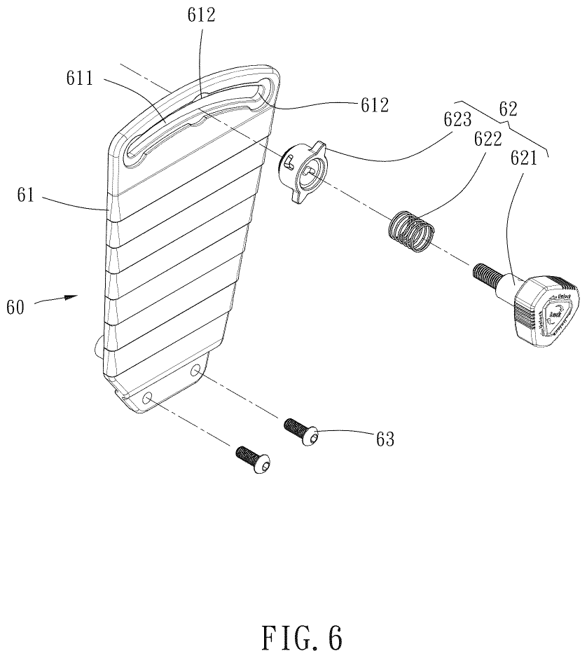

Referring to FIGS. 1 to 6, a sawing machine 10 of the present invention comprises a machine body 20, a saw blade guard 30, a guide mechanism 40, and a covering element 50.

The machine body 20 includes a worktable 21, a machining module 22, and an arm 23. The machining module 22 has a housing 221, a motor 222 installed in the housing 221, a saw blade 224 connected to the motor 222 through a spindle screw 223, and a handle 225 fixed to the housing 221. The arm 23 has an H-shaped structural appearance. The bottom end of the arm 23 is pivotally connected with worktable 21 through a lower shaft 231, and the top end of the arm 23 is pivotally connected with the machining module 22 through an upper shaft 232.

The saw blade guard 30 includes a fixed guard 31 fixed to the housing 221 of the machining module 22, a connecting plate 311 fixed to the fixed guard 31 through two pins 313, and a third guide groove 312 formed on the connecting plate 311. Additionally, the saw blade guard 30 further includes a movable guard 32 and an elastic member 33. The inner surface of the movable guard 32 has a connecting portion 321, a connecting hole 322 provided at the center of the connecting portion 321, and at least one push portion 323 formed on the connecting portion 321. The movable guard 32 is pivotally connected with the connecting plate 311 through a pin 34 inserted in the connecting hole 322. The elastic member 33 is a torsion spring with one end attached to the connecting plate 311 and the other end fixed to the connecting portion 321 of the movable guard 32. When the sawing operation is not performed, the saw blade 224 is covered by the fixed guard 31 and the movable guard 32 for preventing accidental contact by a user. When the sawing operation is performed, the machining module 22 is moved downward relative to the arm 23. At this point, the movable guard 32 is pivoted upward through the tension of the elastic member 33, while the fixed guard 31 remains stationary.

The guide mechanism 40 is a combination of multiple linkages, including a first linkage 41, a second linkage 42, a third linkage 43, and a fourth linkage 44. One end of the first linkage 41 has an elongated first guide groove 411. The first linkage 41 is connected with the movable guard 32 through a pin 45 inserted in the first guide groove 411. The other end of the first linkage 41 is pivotally connected with the second linkage 42. The second linkage 42 has an arc-shaped second guide groove 421, and the second linkage 42 is connected with the housing 221 of the machining module 21 through a pin 46 inserted in the second guide groove 421. One end of the arm 23 is pivotally connected between two ends of the second linkage 42 through the upper shaft 232. The third linkage 43 is parallel to the arm 23. One end of the third linkage 43 is pivotally connected between the two ends of the second linkage 42, with this connection location adjacent to the connection point between the second linkage 42 and the arm 23. The other end of the third linkage 43 is pivotally connected to one end of the fourth linkage 44. The other end of the fourth linkage 44 is fixed to the worktable 21 by using screws 47.

The relative positions of the arm 23, the second linkage 42, the third linkage 43, and the fourth linkage 44 form a quadrilateral shape. Through the motion of the guide mechanism 40, multiple angular position combinations can be achieved, allowing the machining module 22 to be adjusted to multiple positions.

The covering element 50 has a protrusion 51 and a linking hole 52 passing through two opposite sides of the covering element 50. The protrusion 51 is inserted in the third guide groove 312 from one side of the fixed guard 31 and abutted against the push portion 323 of the movable guard 32. A pin 53 is inserted in the third guide groove 312 and the linking portion 52 from the opposite side of the fixed guard 31. In this way, the covering element 50 is movably installed on the fixed guard 31 and designed to precisely cover the spindle screw 223 of the machining module 22, preventing the spindle screw 223 from being disassembled at will. When the movable guard 32 is moved along the first guide groove 411, the movable guard 32 drives the covering element 50 to be pivoted, at which point the spindle screw 223 is exposed.

The present invention further comprises a lock mechanism 60 attached to the arm 23 for limiting the position of the arm 23. The lock mechanism 60 includes a fixed plate 61 and a positioning member 62. The bottom end of the fixed plate 61 is secured to the worktable 21 by using screws 63. The top end of the fixed plate 61 has a positioning slot 611 and a plurality of positioning holes 612 formed at the positioning slot 611. The positioning member 62 has a knob screw 621, a spring 622 disposed on the knob screw 621, and a positioning ring 623 sleeved on the knob screw 621 and the spring 622. The knob screw 621 is inserted into the positioning slot 611 and secured to the arm 23 of the machine body 20, so that the tapered front end of the positioning ring 623 can be engaged with one of the positioning holes 612. The position of the positioning member 62 is fixed within the positioning slot 611 to restrict the position of the arm 23 of the machine body 20. When the positioning ring 623 is pulled, the front end of the positioning ring 623 is separated from the positioning hole 612, allowing the arm 23 to be moved along the positioning slot 611 through the positioning member 62.

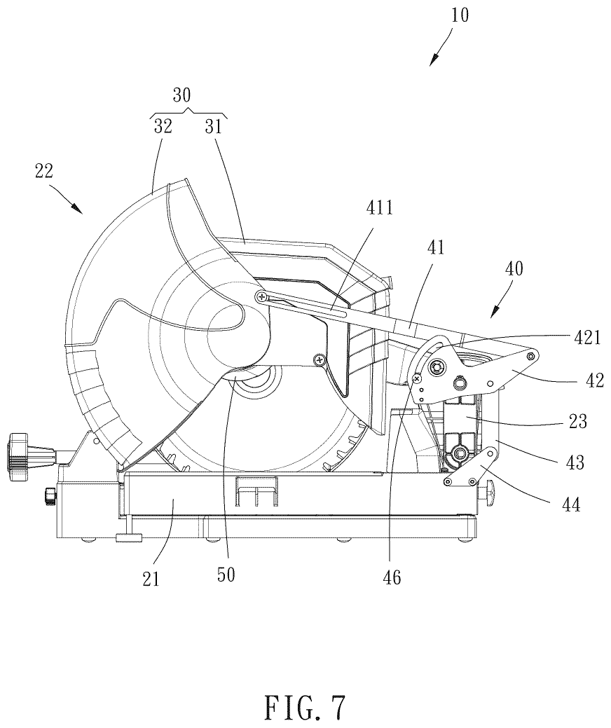

As shown in FIG. 7, when a workpiece is placed on the worktable 21 and securely clamped. The user first adjusts the position and angle of the machining module 22 according to the edge of the workpiece. Then, the motor 222 is activated to drive the saw blade 224 to rotate. At this point, the user grips the handle 225 and applies downward force. The first linkage 41 of the guide mechanism 40 is driven to pivot downward. The arm 23 is restricted in position by the lock mechanism 60, so the machining module 22 is pivoted around the upper shaft 232, while the arm 23 remains stationary. The machining module 22 is pivoted downward along the shape of the second guide groove 421 of the second linkage 42, allowing the machining module 22 to follow a designed path for the sawing operation. This makes precise cuts to the workpiece.

During the downward movement of the machining module 22, the fixed guard 31, which is fixed to the housing 221, is also moved downward. The elastic member 33 experiences a torsional force due to the downward movement of the fixed guard 31. This torsional force is transmitted to the movable guard 32, causing it to be pivoted in a clockwise direction around the pivot points formed by the pin 45 and the pin 34. This results in an automatic lifting function. As a result, the saw blade 224 will only be exposed and come into contact with the workpiece when it is close to the workpiece.

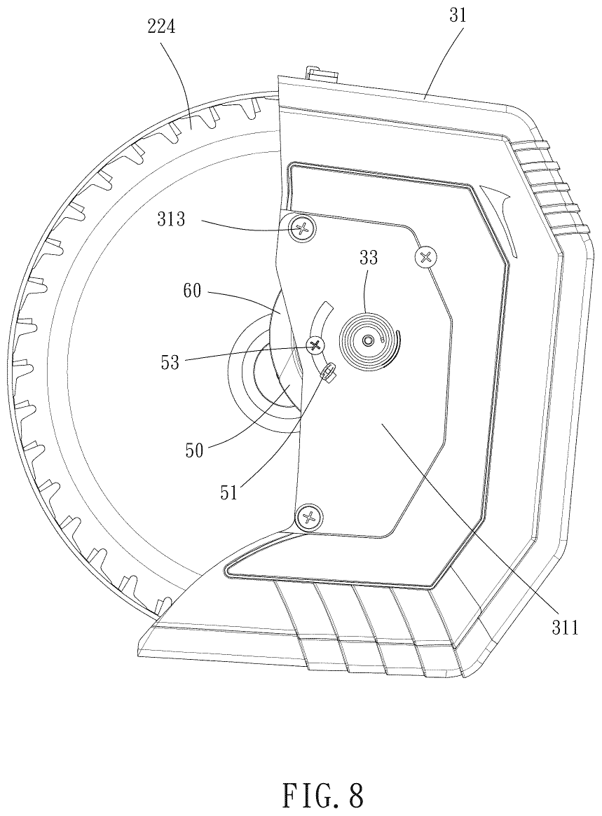

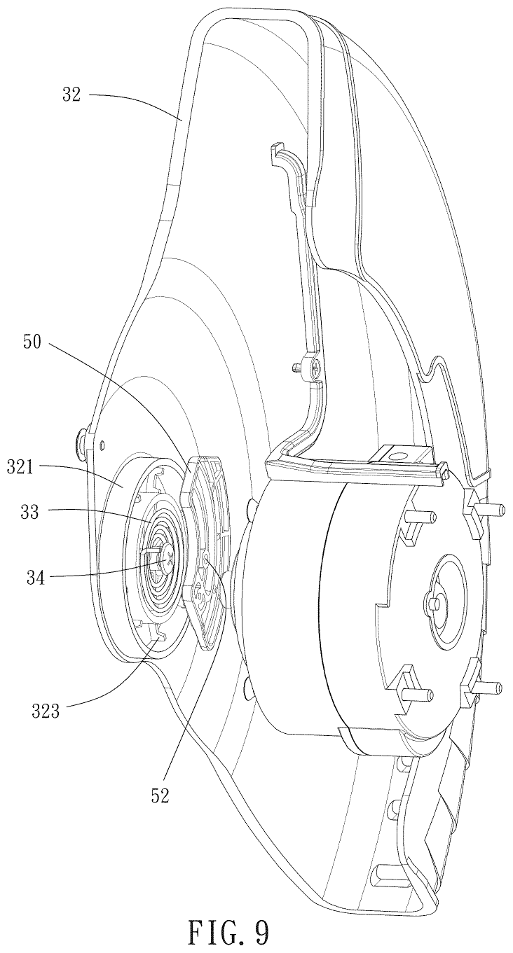

FIGS. 8 to 10 illustrate the procedure for replacing the saw blade 224. FIG. 8 shows the covering element 50 while omitting the movable guard 32. FIG. 9 omits the fixed guard 31 in order to clearly show the relative relationship between the covering element 50 and the movable guard 32.

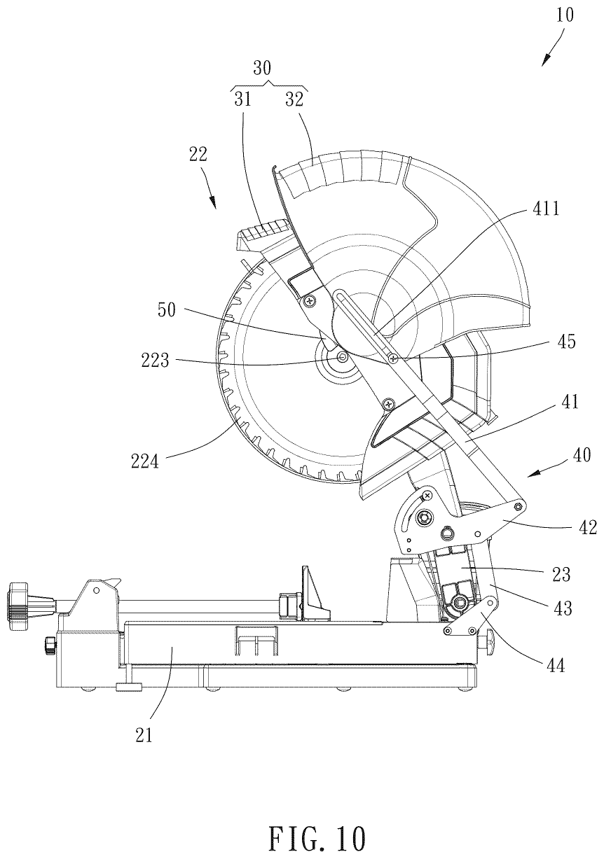

First, the user manually lifts the movable guard 32 to a certain position (similar to the position where the movable guard 32 is automatically lifted during cutting operations). The user then continues to apply force to lift the movable guard 32 upward. Once the user's force overcomes the torsional force applied by the elastic member 33 on the movable guard 32, the elastic member 33 pushes the movable guard 32 upwards to the fixed guard 31. As the movable guard 32 is moved backward, the pin 45 travels from the top end of the first guide groove 411 to the bottom end of the first guide groove 411. At this point, the protrusion 51 of the covering element 50 is pushed by the push portion 323 of the movable guard 32. The covering element 50 is then moved along the third guide groove 312 through the pin 53 (as shown in FIG. 10), thereby exposing the spindle screw 223. This allows the user to use a tool to remove the spindle screw 223 and replace the saw blade 224.

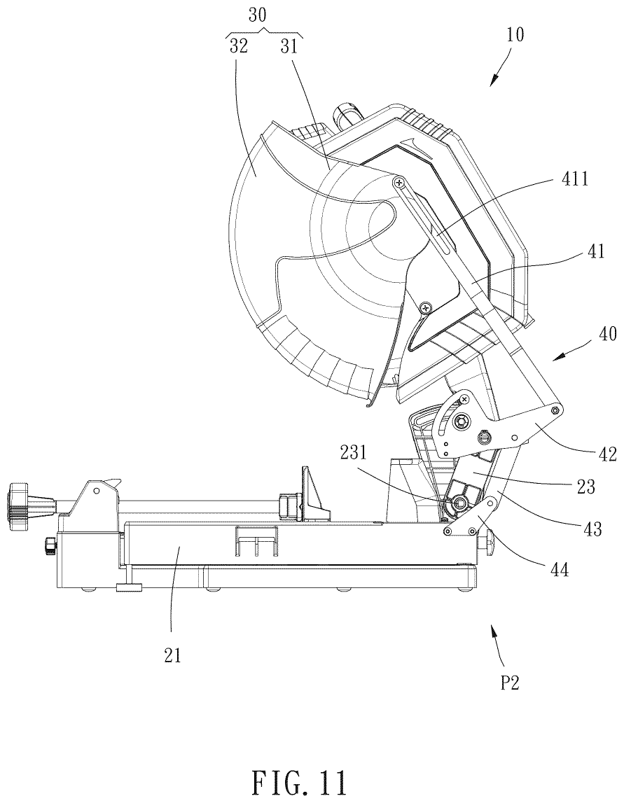

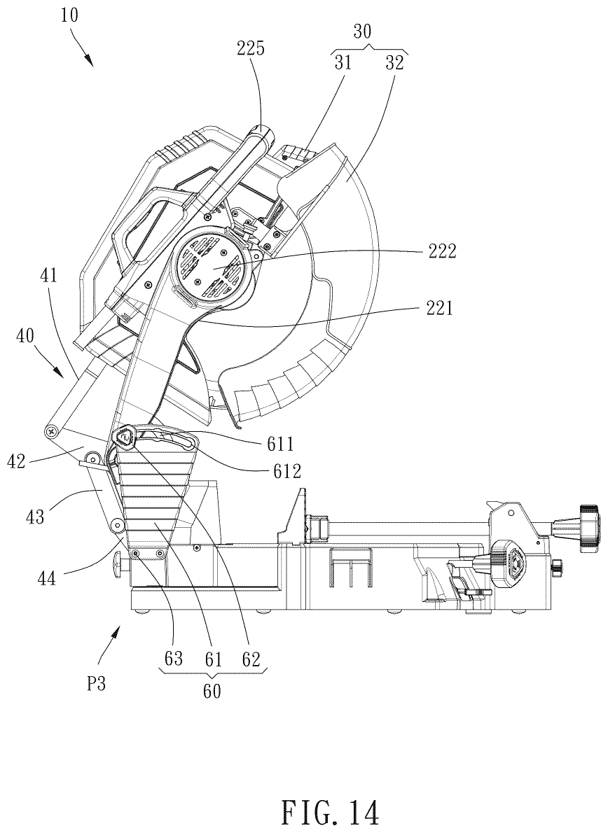

Please refer to FIGS. 1, 11, and 14, the present invention can adjust the angle of the machining module 22 through the arm 23, the guide mechanism 40, and the lock mechanism 60 for adjusting the saw blade 224 to the optimal cutting position. This embodiment provides three modes, showing the angles at which the machining module 22 is positioned when the lock mechanism 60 is in three locking positions.

When the lock mechanism 60 is located at a first position P1, the positioning member 62 is engaged with the positioning hole 612 located at the middle of the positioning slot 611, causing the arm 23 and the third linkage 43 to be perpendicular to the ground. This allows the machining module 22 to be slightly tilted forward.

When the lock mechanism 22 is adjusted from the first position P1 to a second position P2 or a third position P3, the user pulls the positioning ring 623 outward, causing the positioning ring 623 to disengage from the positioning hole 612 while simultaneously compressing the spring 622. At this point, the positioning member 62 can slide along the positioning slot 611, allowing the arm 23 and the guide mechanism 40 to be in a movable state. This enables the user to grip the handle 225 to adjust the position of the machining module 22. As the position of the machining module 22 changes, the arm 23 be moved forward or backward along the positioning slot 611, simultaneously driving the guide mechanism 40 to be moved. Since the second linkage 42 is pivoted relative to the arm 23, through the pivot movement of the second linkage 42 relative to the arm 23, the machining module 22 can also generate slight upward or downward movements, allowing the saw blade 224 to be fine-tuned to an appropriate position. After the adjustment, releasing the force on the positioning ring 623 allows the positioning ring 62 to be engaged with the corresponding positioning hole 612 at the second position P2 or the third position P3 by the restoring force of the spring 622, thereby fixing the position of the arm 23.

When the lock mechanism 60 is located at the second position P2, the positioning ring 623 is engaged with the positioning hole 612 located at the front end of the positioning slot 611, causing the arm 23 and the third linkage 43 to be slightly tilted forward. Thus, the machining module 22 has a greater forward tilt compared to the first position P1. As a result, the position of the saw blade 224 is farther forward, making the cutting position more distant from the arm 23.

When the lock mechanism 60 is located at the third position P3, the positioning ring 623 is engaged with the positioning hole 612 located at the rear end of the positioning slot 611, causing the arm 23 and the third linkage 43 to be tilted backward. Thus, the machining module 22 has a greater backward tilt compared to the first position P1. As a result, the position of the saw blade 224 is farther backward, making the cutting position closer to the arm 23.

Based on the above, the sawing machine 10 of the present invention, compared to the prior art, has at least the following advantages:
1. The fixed guard 31 and the movable guard 32 are connected through the elastic member 33. The characteristic of force transmission through the elastic member 33 allows the movable guard 32 to be lifted relative to the fixed guard 31 when the machining module 22 is moved downward, achieving an automatic lifting function and making the cutting operation safer and more convenient.
2. The movable guard 32 can also be moved along the first guide groove 411 of the guide mechanism 40, driving the covering element 50 to be moved. This allows the parts previously covered by the covering element 50 to be exposed, enabling the user to perform maintenance on the machining module 22 without removing the saw blade guard 30, thereby enhancing work efficiency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sawing machine comprising:
a machine body having a worktable, a machining module, and an arm pivotally connected to the worktable and the machining module;
a saw blade guard attached to the machining module of the machine body and having a fixed guard, a movable guard, and an elastic member connected to the fixed guard and the movable guard, the movable guard being pivotally moved relative to the fixed guard through the elastic member when the machining module is moved downward relative to the arm;
a guide mechanism disposed to the movable guard and having one end thereof connected with the movable guard and provided with a first guide groove; and
a covering element disposed to the saw blade guard and driven to move when the movable guard is moved along the first guide groove of the guide mechanism and pivoted relative to the fixed guard.

2. The sawing machine as claimed in claim 1, wherein the machining module includes a housing, a motor installed in the housing, a saw blade connected to the motor through a spindle screw, and a handle fixed to the housing.

3. The sawing machine as claimed in claim 1, wherein one end of the arm is pivotally connected with the worktable through a lower shaft, and the other end of the arm is pivotally connected with the machining module and the guide mechanism through an upper shaft.

4. The sawing machine as claimed in claim 1, wherein the guide mechanism is connected with the movable guard through a pin inserted in the first guide groove.

5. The sawing machine as claimed in claim 1, wherein the guide mechanism further includes a second guide groove, and the guide mechanism is connected with the machining module through a pin inserted in the second guide groove, allowing the machining module to be moved downward relative to the arm.

6. The sawing machine as claimed in claim 1, wherein the other end of the guide mechanism is fixed to the worktable.

7. The sawing machine as claimed in claim 1, wherein the saw blade guard further includes a connecting plate fixed to one end of the elastic member and a third guide groove formed on the connecting plate; the covering element is penetrated through the third guide groove and abutted against an inner surface of the movable guard, allowing the covering element to be moved along the third guide groove.

8. The sawing machine as claimed in claim 1, wherein the inner surface of the movable guard has a connecting portion fixed to one end of the elastic member, a connecting hole provided at a center of the connecting portion, and at least one push portion formed on the connecting portion and abutted against the covering element; the movable guard is pivotally connected with the fixed guard through a pin inserted in the connecting hole.

9. The sawing machine as claimed in claim 1, wherein the elastic member is a torsion spring.

10. The sawing machine as claimed in claim 1, wherein the covering element includes a protrusion abutted against an inner surface of the movable guard through the fixed guard and a linking hole passing through two opposite sides of the covering element; the covering element is connected with the fixed guard through a pin inserted in the linking hole.
